(19) United States
(12) Patent Application Publication
(10) Pub. No.: US 2004/0221001 A1
(43) Pub. Date: Nov. 4, 2004

(54) Web service architecture and methods

(76) Inventors: Anjali Anagol-Subbarao, Saratoga, CA (US); Rajesh Pradhan, Pacifica, CA (US)

Correspondence Address: HEWLETT-PACKARD COMPANY, Intellectual Property Administration, P.O. Box 272400, Fort Collins, CO, 80527-2400, US

(21) Appl. No.: 10/189,987

(22) Filed: Jul. 5, 2002

(51) Int. Cl. G06F 15/16; G06F 15/163

(52) U.S. Cl. 709/203; 719/311

(57) ABSTRACT

A system for providing web services to a client over a network includes an interface module in communication with the network, an implementation module in communication with the interface module, and a fulfillment module in communication with the implementation module and at least one database. The interface module receives the web service request from the client, passes the request to at least one other component of the system, and passes assimilated data to the client in response to the web service request. The implementation module assimilates data provided by at least one other component of the system in response to the service request. The fulfillment module extracts data from at least one database in response to the service request and provides the extracted data to the implementation module.

### REFERENCE TO CO-PENDING APPLICATIONS

Reference is made to co-pending U.S. patent applications Ser. No. __/______, entitled “ARCHITECTURE AND METHOD FOR PRODUCT CATALOG WEB SERVICE”, having Attorney Docket No. 100204041-1; U.S. Ser. No. __/______, entitled “ARCHITECTURE AND METHOD FOR CONFIGURATION VALIDATION WEB SERVICE”, having Attorney Docket No. 100204037-1; and U.S. Ser. No. __/______, entitled “ARCHITECTURE AND METHOD FOR ORDER PLACEMENT WEB SERVICE”, having Attorney Docket No. 100204039-1; each application filed on like date herewith and having common inventorship and assignment.

### FIELD OF THE INVENTION

The present invention relates to a web services architecture and methods for use, and more particularly, to a web service architecture and methods for use over a network.

### BACKGROUND OF THE INVENTION

Network systems are utilized as communication links for everyday personal and business purposes. With the growth of network systems, particularly the Internet, and the advancement of computer hardware and software technology, an expanding set of services are being offered over the Internet. The types of services offered include, but are not limited to, basic network access, information retrieval, streaming media, teleconferencing and other collaboration tools, business to business and business to consumer offerings, and application outsourcing.

A unique and new type of application being offered over the Internet which facilitates all of the above-referenced services is referred to as a web service. Web services are self-contained, self-describing, modular applications that can be consumed (that is published, located, and invoked) across the Internet or “web” as used interchangeably herein. Web services perform functions which can be anything from simple requests to complicated business processes. Once a web service is deployed, other applications and other web services can discover and use the deployed web service.

Web services are, in some ways, a development of distributed components onto the public Internet. Much in the same way that component “middleware” allows one piece of software to make use of functionality which is contained in another piece of software on another computer, web services use the Internet's protocols to provide a component infrastructure which does the same across the entire Internet.

Web services are desirable because various distributed component platforms which are currently used for distributed computing, such as Common Object Request Broker Architecture (CORBA), Microsoft's Distributed Component Object Model (DCOM), and Sun Microsystems's Remote Method Invocation (RMI), have limited use. In particular, currently available distributed component platforms can generally only be used across a tightly managed network, such as a corporate intranet. They don't work well in open environments such as the public Internet, because they are non-interoperable unless the machines are using the same protocol (e.g., DCOM to DCOM, etc.). However, the Internet does compliment the distributed component platforms by providing a uniform and widely accessible interface.

There are fundamental differences between web services and predecessor distributed networking technology. The primary difference between web services and previous distributed computing technologies is that web services are designed for the heterogeneous environment of the Internet. Because the Internet is composed of a huge number of highly diverse computers which are not under any uniform control which may impose uniform software standards, web services are by necessity completely independent of programming language, operating system and hardware of the computers which comprise the Internet.

Web services are designed for maximum inter-operability across the Internet by integrating web-based applications using Extensible Mark-up Language (XML), Simple Object Access Protocol (SOAP), Web Services Description Language (WSDL), and Universal Description, Discovery and Integration (UDDI) over an Internet protocol backbone. XML is used to tag the data, SOAP is used to transport the data, WSDL is used for defining and describing the services available, and UDDI is used for listing what services are available in a registry.

Web services allow different applications from different sources to communicate with each other without time consuming custom coding. Rather than passing objects, a text format is used so that the transferred data is understandable by all types of systems. Because all communication is in XML, web services are not tied to any one particular operating system or programming language. For example, Java™ can talk with Perl, and Windows applications can talk with UNIX applications. In addition, web services do not require the use of Internet browsers or hypertext mark-up language (HTML) to communicate.

Web services, at a basic level, may thus be considered a universal client server architecture that allows disparate systems to communicate with each other, without using proprietary client libraries. A web services architecture simplifies the development process typically associated with client/server applications by effectively eliminating code or programming dependencies between client and server. No custom connectors or enterprise application integration (EAI) is required. Server interface information is disclosed to the client via a configuration file encoded in a standard format, such as by use of a WSDL file. Doing so allows the server to publish a single file for all target client platforms, such as in a UDDI registry.

In response to dramatic changes in the competitive environment—shorter product life cycles, lower profit margins, and better informed consumers—consumer business activity is rapidly moving to the Internet. Web services will play an important role in this move because of their ability to operate over the heterogeneous systems of the Internet without requiring extensive customization for different client systems. In addition, web services will increase a client's “up time” because of the dynamic discovery nature of web services. The development of web services and systems to provide those services over a variety of channels is thus needed and desirable.

### SUMMARY OF THE INVENTION

A system for providing web services to a client over a network is disclosed. In one embodiment according to the invention, the system includes a server computer in connection with the network. An interface module is in communication with the network via the server computer. An implementation module is in communication with the interface module, and a fulfillment module is in communication with the implementation module and at least one database. The interface module is comprised of software for receiving a web service request from the client, passing the request to at least one other component of the system and passing assimilated data to the client in response to the web service request. The implementation module comprises software for assimilating data provided by at least one other component of the system in response to the service request. The fulfillment module comprising software for extracting data from the at least one, database in response to the service request and providing the extracted data to the implementation module.

### BRIEF DESCRIPTION OF THE DRAWINGS

FIG. 1A is a block diagram illustrating one embodiment of a web service framework according to the invention.

FIG. 1B is a block diagram illustrating one embodiment of a web service architecture on the application server layer according to the invention.

FIG. 2 is a block diagram illustrating one exemplary embodiment of a web service architecture according to the invention.

FIG. 3 is a block diagram illustrating one exemplary embodiment of a product catalog web service transaction implemented on one embodiment of a web service framework and architecture.

FIG. 4 is a class diagram illustrating one exemplary embodiment of a product catalog web service.

FIG. 5 is a sequence diagram illustrating one exemplary embodiment of a product catalog web service.

FIG. 6 is a block diagram illustrating one exemplary embodiment of a product configuration validation web service transaction implemented on one embodiment of a web service framework and architecture.

FIG. 7 is a sequence diagram illustrating one exemplary embodiment of a product configuration validation web service.

FIG. 8 is a block diagram illustrating one exemplary embodiment of a place product order web service transaction implemented on one embodiment of a web service framework and architecture.

FIG. 9 is a sequence diagram illustrating one exemplary embodiment of a place product order web service.

FIG. 10 is a block diagram illustrating one exemplary embodiment of a product order database.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

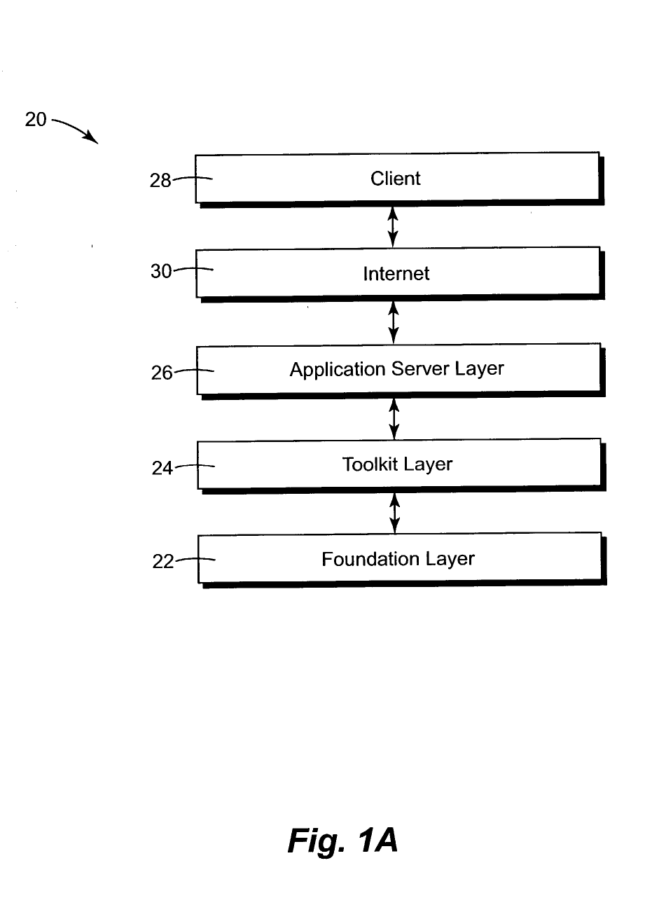

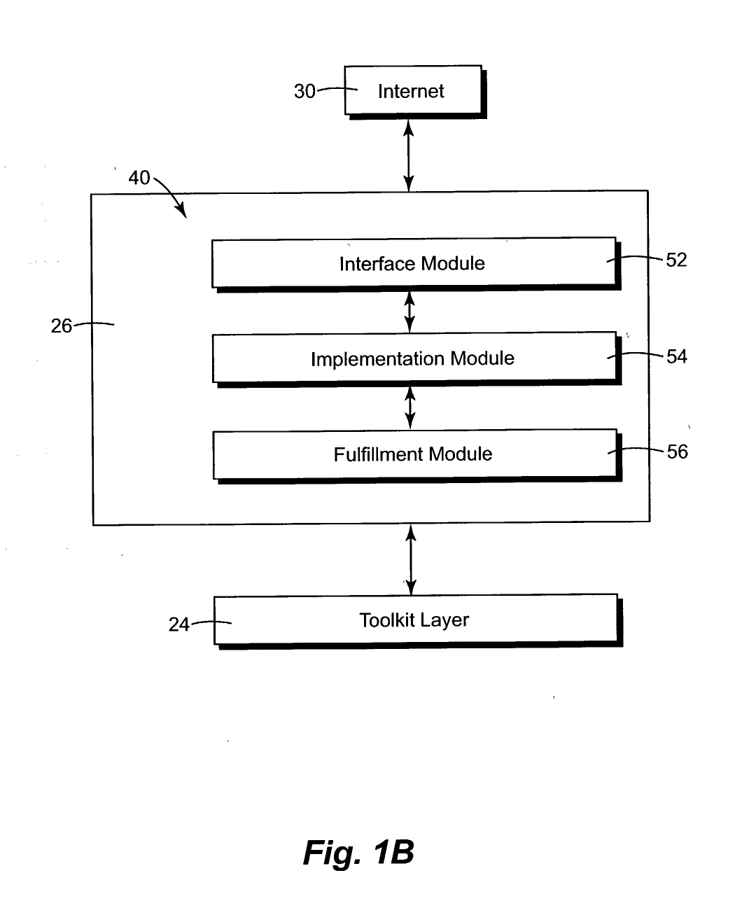

As illustrated in FIG. 1A, a web service framework 20 includes a foundation layer 22 which is the engine or source for the data used to provide requested web services. The foundation layer 22 may comprise, for example, of an enterprise resource planning (ERP) system as discussed in greater detail below. Over the foundation layer 22 is a toolkit layer 24 which acts on requests for web services using data from the foundation layer 22. Toolkit layer 24 is composed of tools required to provide the requested web services using the data in foundation layer 22. As discussed in greater detail below, exemplary tools may include a configurator for checking the configuration of products, databases containing product and pricing catalogs, and databases containing product orders. The next layer in web service framework 20 is an application server layer 26 which contains the web service architecture 40 and is discussed in greater detail below. The web service architecture 40 contained in application server layer 26 receives web service requests, parses data from the service requests, invokes tools in toolkit layer 24 to provide the services, and sends a response to the service request. All web services must be available over some network, and as described herein, the web services are provided to a client 28 over the Internet 30. The network may be based on any open internet protocol such as TCP-IP, HTTP, HTTPS or SMTP, but other kinds of open network protocols may also be used.

Although the term “network” is specifically used throughout this application, the term “network” is defined to include the Internet and other network systems, including public and private networks. Examples include the Internet, intranets, extranets, telephone systems, and other wire line and wireless networks. Although: the term “Internet” is specifically used throughout this application, the term “Internet” is an example of a network and is used interchangeably herein.

The application server layer 26 of FIG. 1A is shown in greater detail in FIG. 1B. The application server layer 26 comprises at least one server computer having an interface for communicating over a network and contains the web service architecture 40. The embodiments of web service architecture 40 disclosed herein according to the present invention include several main modules, each of which comprises one or more software components. In one embodiment web service architecture 40 includes an interface module 52, an implementation module 54, and a fulfillment module 56. Interface module 52 is in communication with Internet 30, which is in turn in communication with a client computing device 28, such as a desktop computer, laptop computer, personal digital assistant (PDA), mobile phone, etc. (collectively referred to hereinafter as “client 28”). Interface module 52 comprises software for receiving a web service request from client 28, passing the request to at least one other component of the system 20, and passing assimilated data to the client 28 in response to the service request. Implementation module 54 is in communication with the interface module 52 and comprises software for assimilating data provided by at least one other component of the system 20 in response to the web service request. Fulfillment module 56 is in communication with implementation module 54 and comprises software for extracting data from at least one database in toolkit layer 24 or foundation layer 22 in response to the web service request, and then providing the extracted data to implementation module 54.

In each module 52, 54, 56 of the web service architecture 40, simple and open protocols and application programming interfaces (APIs) are used for communication between the modules. The modules build upon one another, and each module 52, 54, 56 addresses a separate issue. Web services architecture 40 is thus a unique collection and arrangement of standardized protocols and APIs that permits individuals and applications (collectively referred to herein as clients) to consume web services. Web service architecture 40 provides a system and method which employs a language neutral, environment neutral programming model.

The main software components of web service framework 20 and web service architecture 40 according to the present invention run on one or more computer or server systems. In one embodiment, each of the main software program components runs on its own distributed computer system. In other embodiments, the main software components run concurrently on the same local computer system.

In one aspect, at least a portion of each software component is written in an object oriented programming language in which programmers define not only the data type of a data structure, but also the types of operations (functions) that may be applied to the data structure. In this way, the data structure becomes an object that includes both data and functions. One of the principal advantages of object oriented programming over procedural programming techniques is that they enable the creation of modules that do not need to be changed when a new type of object is added. A new object can be created that inherits many of its features from existing objects. This makes object oriented programs easier to modify. In one embodiment according to the invention, the object oriented programming language is the Java™ programming language, and the invention is described herein with reference to the Java™ programming language. However, those skilled in the art will recognize that other object oriented programming languages may be used. Other suitable object oriented programming languages include C++, Smalltalk, and object-oriented versions of Pascal.

The object oriented programming language and each of the main software components communicate with each other using a transport protocol. In one embodiment according to the invention, the transport protocol is Simple Object Access Protocol (SOAP). Because it is based on existing and well-known Internet protocols, such as TCP-IP, HTTP, etc., SOAP provides a way for applications to communicate with each other over the Internet, independent of platform, by defining a uniform way of passing XML encoded text data. In essence, SOAP provides an “envelope” for sending XML messages. SOAP wraps the XML data and piggy backs onto an Internet protocol to penetrate server firewalls, similar to a web page request. SOAP relies on XML to define the format of the information, and then adds the necessary HTTP headers to send it. Other programming languages and communication protocols suitable for use with the present invention become apparent to one skilled in the art after reading the present application.

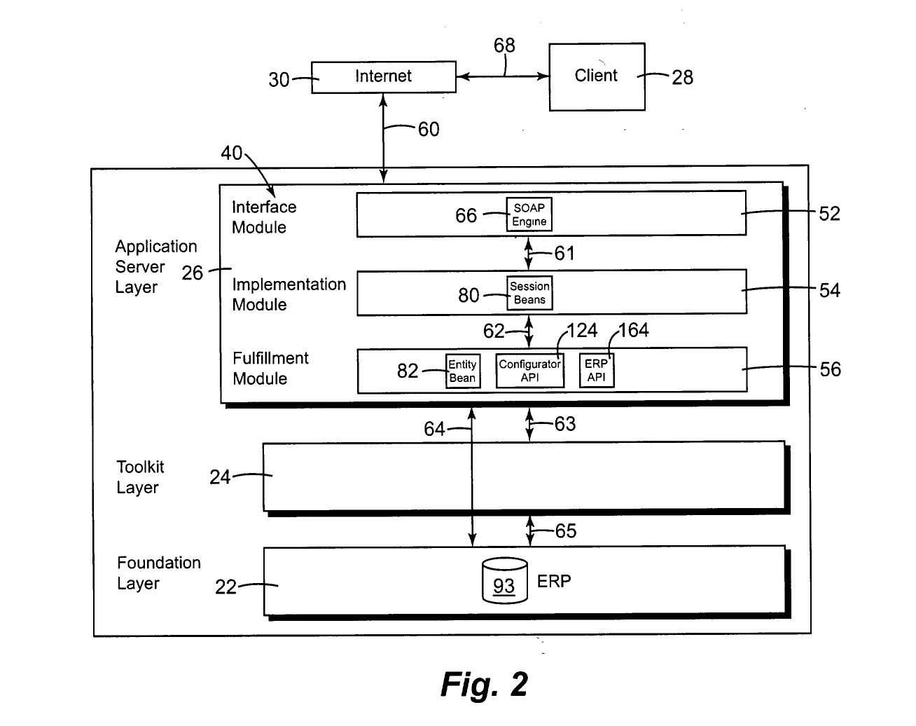

As illustrated in FIG. 2, in one embodiment according to the invention, web services architecture 40 includes interface module 52, implementation module 54, and fulfillment module 56. Interface module 52 is coupled to the Internet 30 via communication link 60, and is also coupled to implementation module 54 via communication link 61. Implementation module 54 is coupled to fulfillment module 56 by communication link 62. Fulfillment module 56 is coupled to toolkit layer 24 and foundation layer 22 by communication links 63, 64, respectively, while toolkit layer 24 and foundation layer are coupled via communication link 65. Interface module 52, implementation module 54, and fulfillment module 56 communicate via one or more communication protocols which are selected as appropriate for the various components of modules 52, 54, 56. For example communication protocols such as SOAP, remote method invocation (RMI) and Java™ Database Connectivity (JDBC) may be used.

In one exemplary embodiment according to the invention, a SOAP engine 66 is used in interface module 52, while Enterprise JavaBean™ (EJB) technology is used in implementation module 54 and fulfillment module 56. Specifically, Java™ session beans 80 are used in implementation module 54 to distribute and isolate processing tasks, and Java™ entity beans 82 are used in fulfillment module 56 to interact with the various tools in toolkit layer 24. The communication protocol between interface module 52 and implementation module 54 is SOAP, the communication protocol between implementation module 54 and fulfillment module 56 is RMI, and the communication protocol between fulfillment module 56 and the tools and databases in toolkit layer 24 is JDBC.

The interface module 52, in the above-described embodiment according to the invention, comprises a SOAP engine 66. The SOAP engine 66 has a generic listener which listens to service calls received from client 28. Interface module 52 functions to receive a service call (sent using XML over SOAP) for a particular web service from client 28 via a communication link 68 with Internet 30. The SOAP engine parses the XML to remove the SOAP “envelope”, identifies the uniform resource locator (URL) from which the service call originated, identifies the requested service and service parameters, and the data type, and then invokes the required business logic to provide the requested service.

The interface module 52 is object oriented programming based for portability, and is component based for plug and play ability. In one embodiment according to the invention, interface module 52 includes Java™ API for XML Messaging (JAXM) to enable the sending and receiving of document oriented XML messages using a pure Java™ API. In another embodiment according to the invention, interface module 52 includes Java™™ API for XML-based RPC (JAX-RPC). JAX-RPC enables web services incorporating XML-based remote procedure call (RPC) functionality according to SOAP specifications. The RPC mechanism enables a remote procedure call from client 28 to be communicated to a remote server. In XML-based RPC, a remote procedure call is represented using an XML-based protocol such as SOAP. An XML-based RPC server application can define, describe and export a Web service as an RPC-based service. JAX-RPC can also be used to implement services described by WSDL.

Various versions of SOAP are available commercially, such as HP-SOAP, Apache Soap and Apache Axis. One or more of these and other versions of SOAP may be used in interface module 52, depending upon the features desired.

Implementation module 54 provides “logical containers” for the business logic required to provide the requested web service. As discussed above, in one embodiment according to the invention, implementation module 54 features Enterprise JavaBean™ technology (EJB) for portability, and is component based for plug and play ability. In the embodiment shown in FIG. 2, the implementation module 54 uses session beans 80 to distribute and isolate processing tasks required to provide the requested service. The session beans 80 are invoked by the interface module 52 after the interface module 52 has received the service call from the client 28 and determined what web service has been requested.

The fulfillment module 56 executes the processing tasks required by the implementation module 54 to provide the requested service. The fulfillment module 56,is in communication with the tools and databases in the toolkit layer 24 and/or foundation layer 22 that contains the data necessary to provide the requested service. In one embodiment according to the invention, the fulfillment module 56 features Enterprise JavaBean™ (EJB) technology for portability, and is component based for plug and play ability. In the embodiment shown in FIG. 2, the fulfillment module 56 uses entity beans 82 to interact with the appropriate tools and databases in the toolkit layer 24 and/or foundation layer 22 and execute the required processing tasks. The entity beans 82 are invoked by the session beans 80 of implementation module 54. In addition to entity beans 82, fulfillment module 56 may additionally use application programming interfaces (APIs) to interact with specific tools and databases in toolkit layer 24 and/or foundation layer 22.

The web service architecture 40 described above may be used to provide numerous and diverse services over the Internet. Although the services provided by the web service framework and architecture described herein may appear similar to some existing services, the web service framework and architecture according to the present invention differs significantly. For example, multiple retailers may offer an in-store computer kiosk where a customer can configure and order a custom or semi-custom product (i.e., a “configure-to-order” product) from a manufacturer. That kiosk, however, is part of a distributed computing network that has been custom developed for the specific retailer and is part of a carefully managed and homogeneous network. Offering new services via the kiosks requires unique and custom changes to each retailer's system, which is both time consuming and expensive. In contrast, the modular nature of the architecture 40 is adaptable for diverse clients and transactions. Individual modules 52, 54, 56 or elements within the modules 52, 54, 56 may be easily altered, reused, added or subtracted from the architecture to provide new or different web services without impact on other modules. Changes to the architecture 40 are immediately available to all clients 28 without custom development for each client. Real-time access to the web services by client 28 (the web service requests are acted upon immediately) allows architecture 40 to use real-time processing of the web service requests, rather than requiring off-line processing. This provides a benefit to client 28 in that the requested services are provided immediately.

As a significant benefit, the web service architecture 40 is platform agnostic. That is, the web service architecture 40 may be deployed on or interact with platforms developed in, for example, Sun Microsystems' Java™ 2 Platform, Enterprise Edition (J2EE) or Microsoft's .NET platforms. The architecture 40 is also device agnostic in that the web services may be accessed by both hardwired network devices (such as computers) and by wireless devices such as cell phones or personal digital assistance (PDAs). The web service architecture 40 is component based and the components are reusable for multiple web services. The architecture 40 described above also provides the capability for customizing data for a particular client account. The capability for connecting to a Structured Query Language (SQL) server, an ERP such as SAP AG's R/3 integrated suite, and an internet pricing and configuration (IPC) database is also provided. Multiple input and output formats are supported. The input and output formats may include any text related format, for example, EDI, XML, or flat file.

The web service architecture 40 may be used to provide web services including, but not limited to, providing a customized product catalog, validating a product configuration, or placing a product order. Implementation of exemplary web services is discussed in greater detail below. The web service architecture 40 and methods described below are discussed in the context of “configure-to-order” products, such a computers that may be ordered in custom configurations. It will be readily apparent that the architectures and services are equally applicable to other types of products, and the following detailed description, therefore, is not to be taken in a limiting sense, and the scope of the present invention is defined by the appended claims

Product Catalog Web Service

In one embodiment, the web service framework 20 and web service architecture 40 described above may be used-to provide a product catalog web service. In particular, information required for populating remote product catalogs and for remote presentation of product catalogs may be supported. The product, catalog web service may provide information including available product families, product models, product options, and rules for building “configure-to-order” (i.e.,. customized) products.

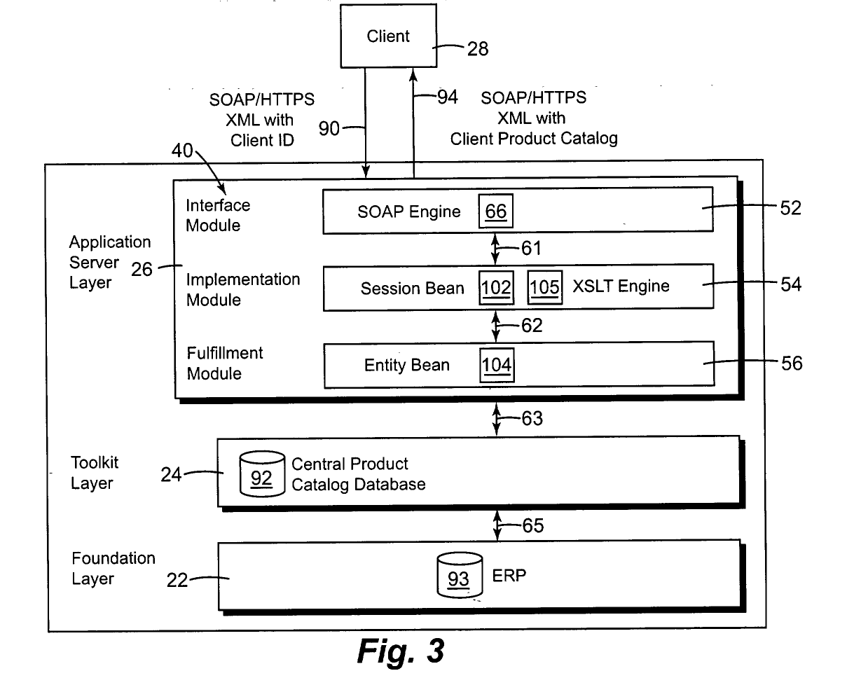

FIG. 3 shows an embodiment of a web service framework and architecture for implementing a product catalog web service transaction in which a client 28 invokes a product catalog web service 90 using XML over SOAP. Once received by the interface module 52, the client identification is extracted by SOAP engine 66 and used by the implementation module 54 and fulfillment module 56 to extract and assimilate data from a central product catalog database 92 in toolkit layer 24. Central product catalog 92 may be populated with data from enterprise resource planning (ERP) database 93, for example.

In greater detail, the client identification is passed from interface module 52 to implementation module 54 to invoke the business logic required to provide the requested service (i.e., a product catalog). In one embodiment according to the invention, implementation module 54 uses session bean 102 to implement the business logic and invoke entity bean 104 in fulfillment module 56. Entity bean 104 extracts the specific products and prices for the identified client from the central product catalog database 92. In one embodiment according to the invention, the product catalog is cached offline (after the service request is received, and prior to the catalog being returned to the client). Offline caching may be desired if the size of the catalog is sufficiently large to require relatively long periods of time to extract the required information from the central product catalog database 92.

The extracted and assimilated data is then used in the generation of a customized product catalog in the format associated with the client identification. In the embodiment illustrated in FIG. 3, the customized product catalog is an XML file generated using an extensible style language transformation (XSLT) engine 105 in implementation module 54. In other embodiments, the customized product catalog may be, for example, an HTTP page, a flat file, or any other text related format. In addition, each type of customized product catalog format (XML, HTTP, flat file, etc.) may have any number of variations in its format depending upon the specifications of client 28. In response to the client's invocation 90 of the, product catalog web service, the client's customized product catalog 94 (in XML format in the illustration of FIG. 3) is then communicated to client 28 using XML over SOAP.

In one embodiment of a product catalog web service, the interface module 52 uses, for example, HP-SOAP or another suitable version of SOAP, such as Apache SOAP or Apache Axis. The product catalog files may be transmitted as attachments, with the document exchange occurring via XML.

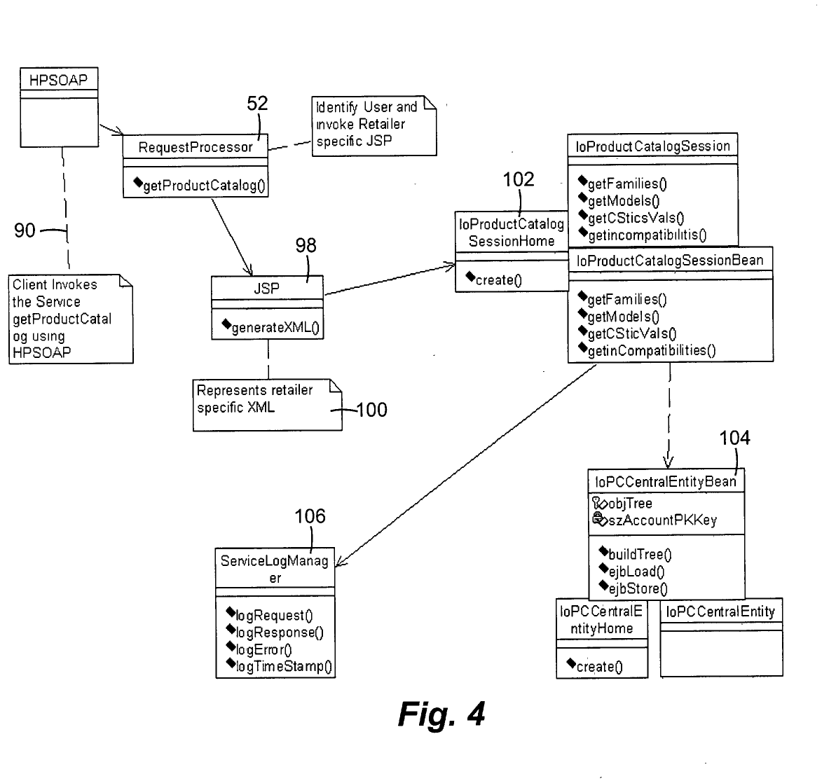

A class diagram of one embodiment of a product catalog web service according to the invention is shown in FIG. 4. When the client 28 invokes the product catalog web service 90 using XML over SOAP to obtain a customized product catalog, the service call is processed (RequestProcessor) by the interface module 52 to identify the client 28, and a client-specific Java™ server page (JSP) 98 is invoked. The first time the product catalog web service is requested, JSP 98 invokes the appropriate session bean 80, which in turn invokes the entity bean 82 required to generate a generic XML file. The generic XML file is then transformed to a client specific XML file 100 which represents the format of the client's specific XML product catalog 94. After the first time the product catalog web service 90 is requested, the generic XML file does not need to be regenerated if it is saved after its initial creation. The JSP 98 also invokes the central product catalog session bean 102, which in turn invokes the central product catalog entity bean 104. The entity bean 104 interacts with the central product catalog database 92 and retrieves the product families (getFamilies), product models (getModels), product options (getCSticsVals), and rules (getinCompatabilities) for building “configure-to-order” products. A product catalog customized to the client is then generated by the JSP 98 and returned to the client 28. In one embodiment of the invention, a service log manager 106 may also be invoked by the product catalog session bean 102 to log the service requests, responses, errors and time stamps of the web service.

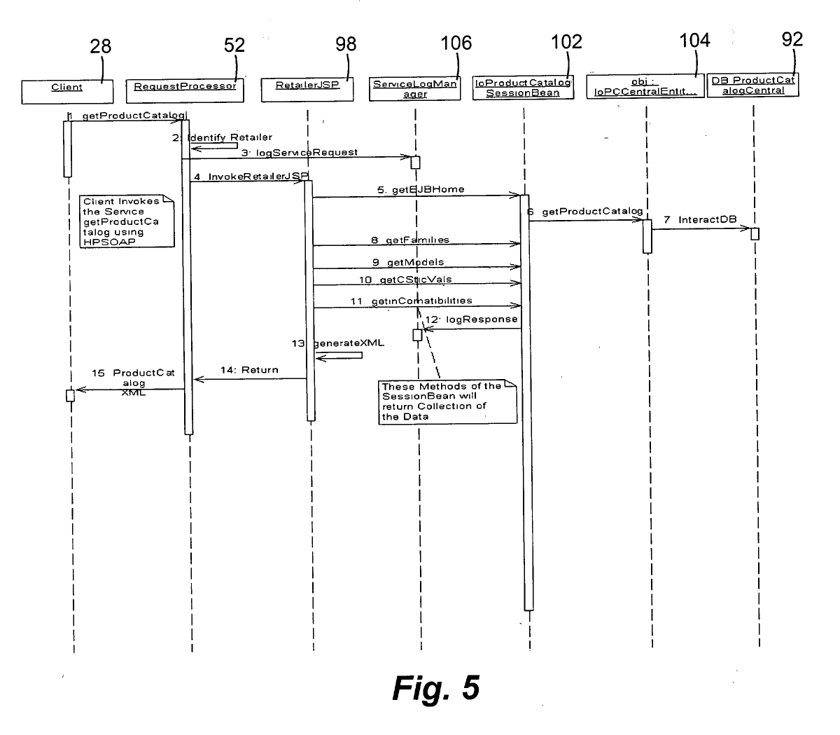

In FIG. 5, a sequence diagram is presented which shows one possible sequence of the actions described above with respect to the class diagram of FIG. 4. Those skilled in the art will recognize that other sequences are readily implemented. First, when client 28 invokes the product catalog web service toy obtain a product catalog, interface module 52 functions as a request processor and identifies the particular client 28 (a retailer in the example of FIG. 5). The service request is then logged with the service log manager 106. The client specific JSP 98 is then invoked to determine which product families, product models, product options, and rules for building configure to order products are applicable to the specific client 28. Session bean 102 is then invoked to carry out the business logic of the service request. Session bean 102 invokes entity bean 104 to interact with the central product catalog database 92 and extract the product families (getFamilies), product models (getModels), product options (getCSticsVals), and rules (getinCompatabilities) for building configure to order products. Session bean 102 logs the response from entity bean 104 as the extracted data from the central product catalog database 92 is returned. An XML based product catalog is generated using the previously invoked JSP 98. The XML based product catalog is then returned to the client 28 through the interface layer 52 via XML over SOAP.

Validate Product Configuration Web Service

In another embodiment, the web service framework 20 and web service architecture 40 described above may be used to validate the configuration of a product, such as when a client is ordering a custom or “configure-to-order” product.

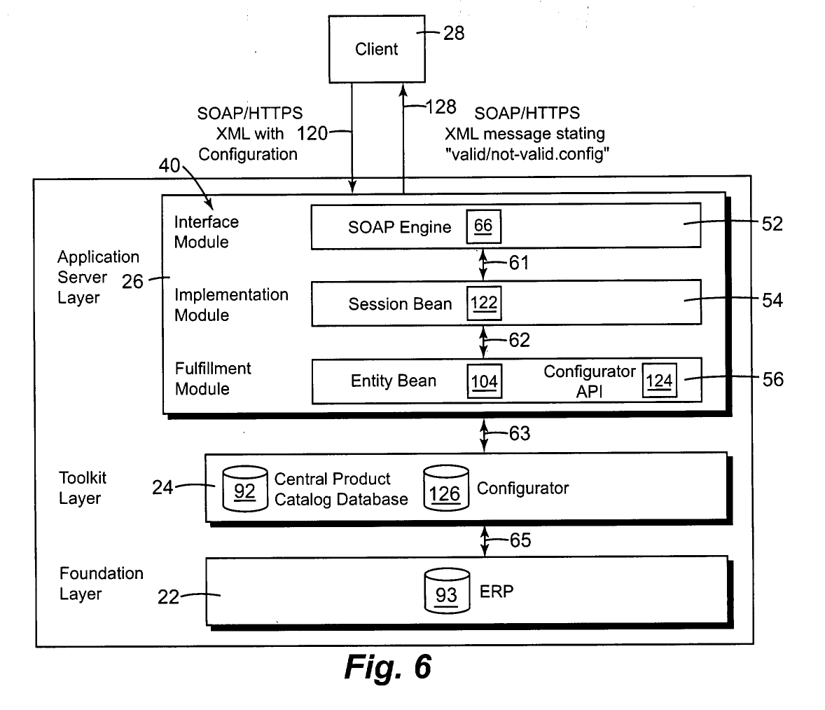

FIG. 6 shows an embodiment of a web service framework and architecture for implementing a validate product configuration web service transaction in which a client 28 transmits a web service request 120 for the validate configuration service using XML over SOAP. The service request 120 includes a product configuration which the client 28 desires to have validated. When the validate product configuration service request 120 is received by the interface module 52, the interface module 52 identifies the request as a validate configuration request and invokes a validate product configuration session bean 122 in implementation module 54.

In one embodiment according to the invention, validating the submitted product configuration includes two steps; first confirming that the submitted product configuration is in fact a product, and second, confirming that the submitted product configuration is valid. The validate configuration session bean 122 thus first invokes entity bean 104 in fulfillment module 56 to interact with central product catalog 92 and confirm that the submitted product configuration is in fact a product. If the submitted product configuration is confirmed to be a product, session bean 122,next invokes a configurator application program interface (API) 124 in the fulfillment module 56. Configurator API 124 interacts with configurator database 126 to validate the submitted product configuration in real time and return an answer 128 to client 28. The answer 128 would include a message such as “product configuration valid” or “product configuration not valid”, together with any error messages explaining an invalid configuration to client 28. If desired, in another embodiment according to the invention, the step of confirming that the submitted product configuration is in fact a product may be omitted.

In one embodiment of a validate product configuration web service, the interface module 52 uses, for example, HP-SOAP or another suitable version of SOAP, such as Apache SOAP or Apache Axis. In the fulfillment module 56, the configurator API 124 may be, for example, SAP AG's configurator IPC 2.0. The configurator database 126 may be, for example, a sales, pricing and configuration (SPC) database available from SAP AG.

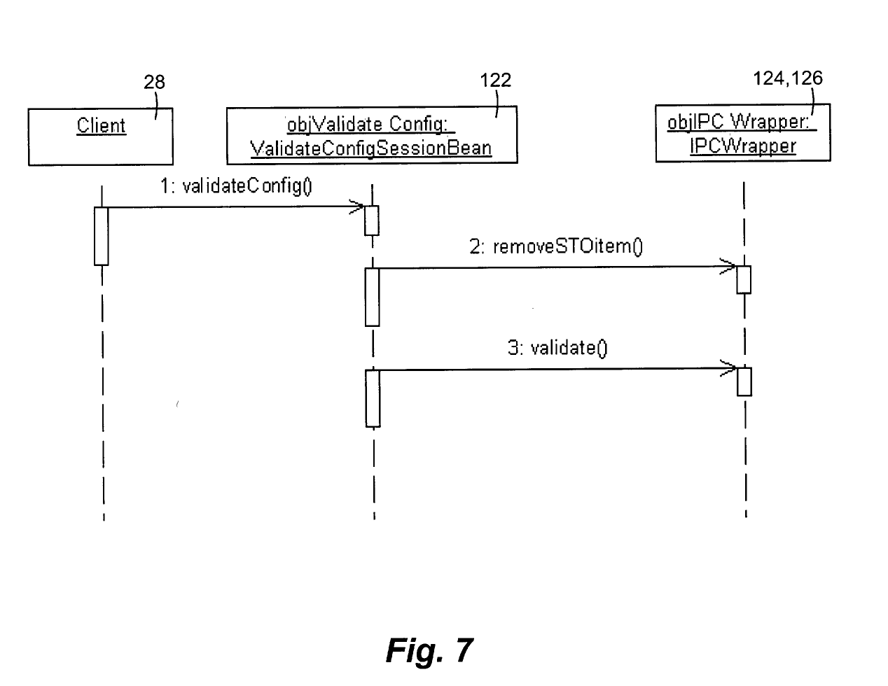

A sequence diagram of one embodiment of a validate product configuration web service according to the invention is shown in FIG. 7. When the client 28 invokes the validate product configuration web service (using XML over SOAP) to validate a product configuration, the service call invokes a validate configuration session bean 122. Session bean 122 removes non-customized or ”stock-to-order” products (removeSTOitem) from the service request, as stock-to-order products by definition have a valid configuration. The validate configuration session bean 122 also invokes configurator API 124 to interact with the configurator database 126 and validate the submitted product configuration. After the configuration has been validated, answer 128 is passed to client 28 with either a “valid” or “not valid” result. Other information may also be passed to client 28, such available ship dates; for the submitted product configuration.

Place Product Order Web Service

In another embodiment, the web service framework 20 and web service architecture 40 described above may be used to provide a place product order web service. In particular, the service may gather information required for filling a product order and initiate the order fulfillment process.

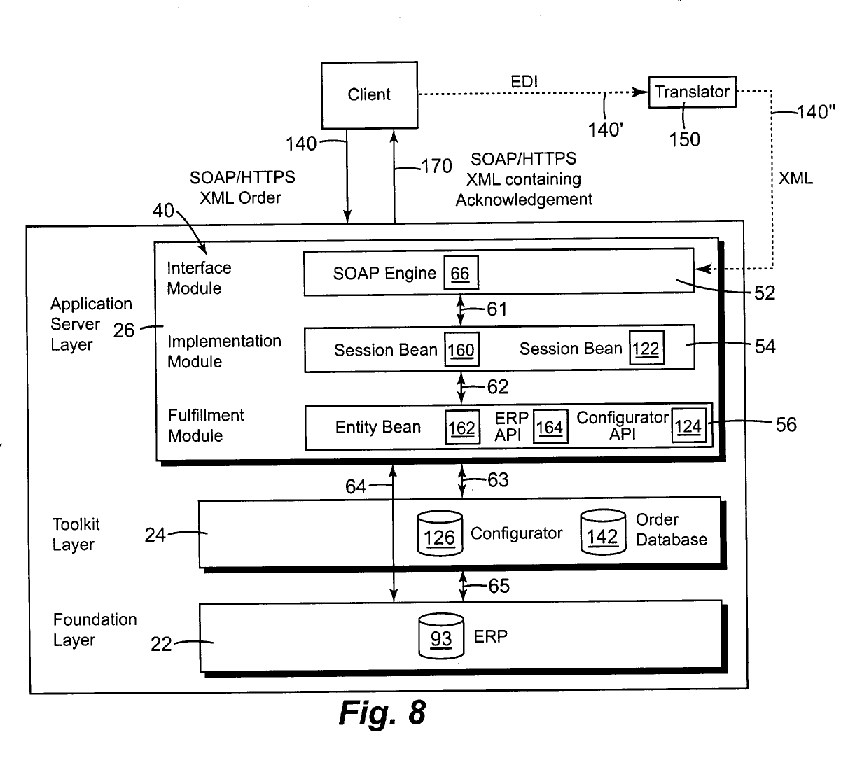

FIG. 8 shows an embodiment of a web service framework and architecture for implementing a place product order transaction in which a client 28 transmits a place product order web service request 140 using XML over SOAP. The place product order web service request 140 may include information such as the desired product configuration, client and customer data (account numbers, address, etc.), shipping address, billing information, shipping options, etc. Once received by implementation module 52, a place order session bean 160 is invoked to implement the business logic required to provide the requested service. Session bean 160 invokes a place order entity bean 162 and also an application program interface 164 configured to interact with ERP 93. API 164 places the product order into the order fulfillment system/database of ERP 93 to initiate the process of filling the order. The order may additionally be placed in a separate order database 142 by entity bean 162 for purposes such as order backup, tracking, customer service, etc.

In some instances, and for a variety of reasons, order placement by the client 28 may not be possible using XML over SOAP. In such situations, the client 28 may initiate a place product order service request using another system, such as an electronic data interchange (EDI). A place product order transaction flow using EDI is illustrated by the dashed lines in FIG. 8. When placing a product order service request 140′ using EDI, the service request 140′ and required data must be translated to an XML formatted request 140″. The EDI to XML translation is accomplished using a translator 150. The translator 150 translates the EDI formatted request 140′ to an XML formatted request 140″ prior to its communication with interface module 52. The translated request 140″ is sent to interface module 52 via XML over SOAP and web service request 140″ is processed in the same manner as request 140 which originated as an XML formatted request.

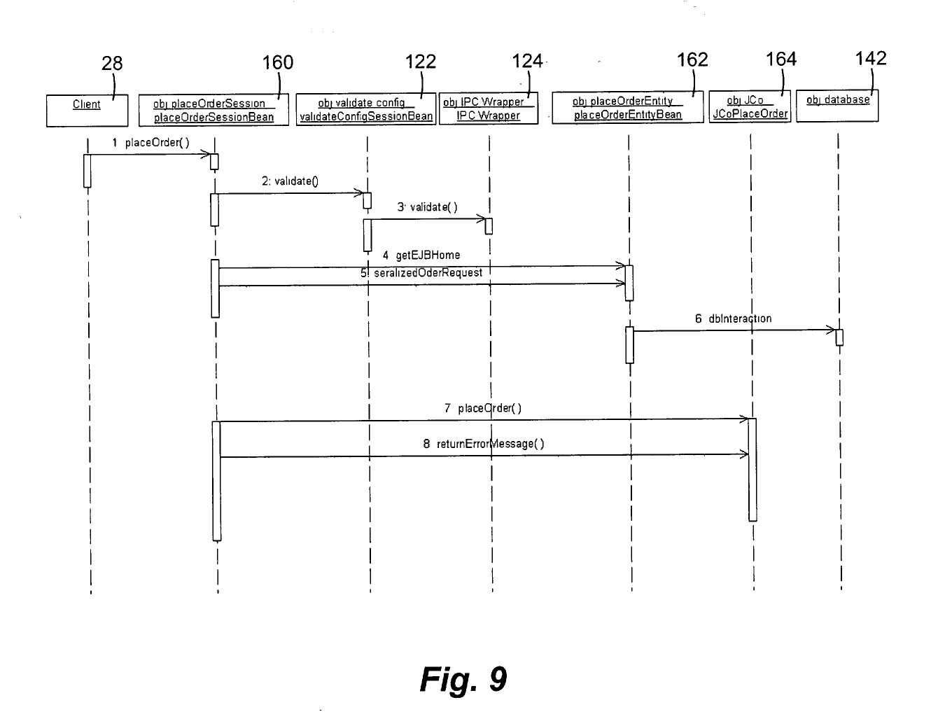

FIG. 9 illustrates one possible sequence of operations which occur when a place product order service request 140 or 140″ is sent by client 28. After service request 140, 140″ is received, a place order session bean 160 is invoked. If the product configuration has not been previously validated, or to confirm the validation of the ordered product configuration, the place order session bean 160 first invokes the validate product configuration session bean 122, which in turn invokes configurator API 124 to provide the validate configuration service as described in greater detail above. After the product configuration is validated, place order session bean 160 next invokes a place order entity bean 162 and then serializes the order request. The place order entity bean 162 interacts with the order database 142 to record the specified data into the database 142. The place order session bean 160 then invokes ERP API 164 to place the product order into the order fulfillment system/database of ERP 93 and initiate filling of the order (such as by sending the order to a factory). Any appropriate error messages 170 regarding the order or product configuration will then be returned to the client 28 so that any needed corrections may be made.

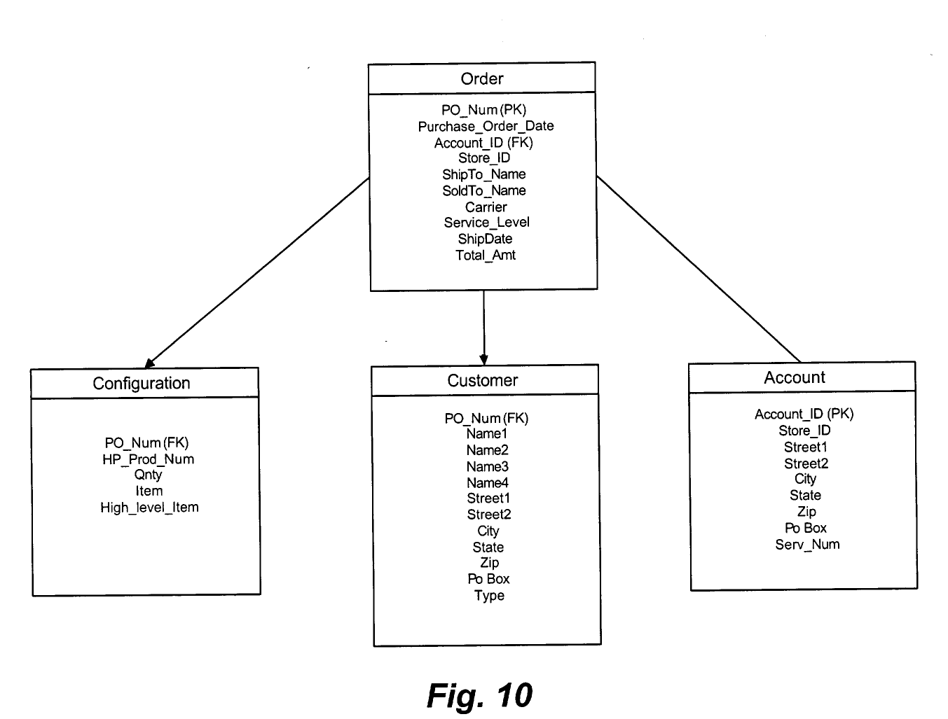

In one embodiment according to the invention, the order database 142 will include a variety of information as shown in FIG. 10. Exemplary order information includes data regarding the product configuration, the customer and the customer account. Specific examples of data include a purchase order number, purchase date, account ID, product configuration, shipping addresses, etc. In one embodiment according to the invention, the order fulfillment system/database is, for example, SAP AG's R/3 enterprise resource program suite.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with, skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A system for providing web services comprising:
at least one server computer having an interface for communicating over a network;
an interface module in communication with the server computer, the interface module comprising software for receiving a service request from a client, passing the request to at least one other component of the system, and passing assimilated data to the client in response to the service request;
an implementation module in communication with the interface module, the implementation module comprising software for assimilating data provided by at least one other component of the system in response to the service request; and
a fulfillment module in communication with the implementation module, the fulfillment module comprising software for extracting data from at least one database in response to the service request and providing the extracted data to the implementation module.

2. The system of claim 1, wherein the interface module, implementation module and fulfillment module are hosted on the server computer.

3. The system of claim 1, where the at least one database includes a product catalog database.

4. The system of claim 1, where the at least one database includes a product configurator database.

5. The system of claim 1, where the at least one database includes a product order database.

6. The system of claim 1, where the at least one database includes an enterprise resource planning database.

7. The system of claim 1, wherein the interface module comprises a SOAP engine.

8. The system of claim 7, wherein the SOAP engine is HP-SOAP.

9. The system of claim 7, wherein the SOAP engine is Apache SOAP.

10. The system of claim 7, wherein the SOAP engine is Apache Axis.

11. The system of claim 1, wherein the implementation and fulfillment module software comprises object oriented programming.

12. The system of claim 11, wherein the implementation and fulfillment modules software comprise Enterprise Java Beans.

13. The system of claim 12, wherein the implementation module software comprise Java Session Beans.

14. The system of claim 12, wherein the fulfillment module software comprise Java Entity Beans.

15. The system of claim 11, wherein the object oriented programming is Java.

16. The system of claim 1, wherein the interface module communicates with the implementation module using SOAP.

17. The system of claim 1, wherein the implementation module communicates with the fulfillment module using RMI.

18. The system of claim 1, wherein the fulfillment module communicates with the database using JDBC.

19. An apparatus for providing a web service comprising:
a foundation layer containing data required to provide a web service;
a toolkit layer containing software tools to provide the web service using data from the foundation layer;
an application server layer containing software modules for receiving the a web service request from a client and invoking software tools in the toolkit layer to provide the web service; and
at least one server computer in communication the application server layer and a computer network.

20. The apparatus of claim 19, wherein the software modules of the application server layer comprise:
an interface module in communication with the computer network, the interface module comprising software for receiving a web service request, passing the request to at least one other component of the framework, and passing assimilated data to the client in response to the web service request;
an implementation module in communication with the interface module, the implementation module comprising software for assimilating data provided by at least one other component of the framework in response to the service request; and
a fulfillment module in communication with the implementation module, the fulfillment module comprising software for interacting with tools in the toolkit layer in response to the web service request.

21. The apparatus of claim 20, wherein the fulfillment module further comprises software for interacting with data in the foundation layer in response to the web service request.

22. The apparatus of claim 19, wherein the computer network is the internet.

23. The apparatus of claim 19, wherein the foundation layer includes an enterprise resource planning database.

24. The apparatus of claim 19, wherein the toolkit layer includes a product catalog database.

25. The apparatus of claim 19, wherein the toolkit layer includes a configurator database.

26. The apparatus of claim 19, wherein the toolkit layer includes a product order database.

27. The apparatus of claim 19, wherein the software modules of the application server layer use object oriented programming.
